(19) United States
(12) Patent Application Publication
(10) Pub. No.: US 2017/0314659 A1
(43) Pub. Date: Nov. 2, 2017

(54) Power Transmission System for Vehicle and Manufacturing Method for the Same

(71) Applicant: TOYOTA JIDOSHA KABUSHIKI KAISHA, Toyota-shi (JP)

(72) Inventors: Yosuke MICHIKOSHI, Toyota-shi (JP); Masashi IKEMURA, Toyota-shi (JP)

(73) Assignee: TOYOTA JIDOSHA KABUSHIKI KAISHA, Toyota-shi (JP)

(21) Appl. No.: 15/494,117

(22) Filed: Apr. 21, 2017

(30) Foreign Application Priority Data
Apr. 28, 2016 (JP) 2016-091152

(51) Int. Cl. F16H 35/10; F16D 7/02; F16H 3/66

(52) U.S. Cl. CPC F16H 35/10; F16H 3/663; F16D 7/021; F16H 2200/2046; F16H 2200/006; F16H 2200/2066; F16H 2200/2082; F16H 2200/201

(57) ABSTRACT

A tolerance ring is formed in an inner circumference of a clutch drum at a more forward position than a spline-fitted part in a forward direction during assembly of the clutch drum to a third sun gear; thus, the tolerance ring is located closer to an axial end of the clutch drum than to the spline-fitted part. Accordingly, it becomes easier to carry out grooving to form an annular groove for housing the tolerance ring therein in the inner circumference of the clutch drum, and thereby deterioration of machinability is suppressed.

### INCORPORATION BY REFERENCE

The disclosure of Japanese Patent Application No. 2016-091152 filed on Apr. 28, 2016 including the specification, drawings and abstract is incorporated herein by reference in its entirety.

### BACKGROUND

### 1. Technical Field

The present disclosure relates to a power transmission system for a vehicle equipped with a spline-fitted part that is formed by spline-fitting a first rotary body and a second rotary body to each other, and also to a manufacturing method for the same.

### 2. Description of Related Art

There have been known structures in which second rotary bodies having greater diameters than those of first rotary bodies are fitted to outer circumferences of the first rotary bodies so that tolerance rings are provided between respective parts of the first rotary bodies and the second rotary bodies that overlap each other in the radial direction. Japanese Patent Application Publication No. 2012-52638 discloses a structure in which a tolerance ring 10 is provided between both shaft members S1, S2 that compose a dual-shaft shape. The tolerance ring 10 of JP 2012-52638 A allows axial centers of both the shaft members S1, S2 to coincide with each other, functions as a torsion reducing mechanism, and also functions as a torque limiter if a predetermined torsion torque or more is transmitted thereto.

### SUMMARY

Meanwhile, in the above disclosure, it is mentioned that the tolerance ring is provided between both the shaft members, but there is no mention about assembly thereof. For example, if a tolerance ring is provided in a structure having a spline-fitted part formed by spline-fitting some of rotary elements of a planetary gear unit that composes a transmission to rotary elements of another planetary gear unit, some of rotary elements composing a clutch (or a brake), or some of non-rotary members, a space around the spline-fitted part is limited; thus, it might be difficult to carry out machining to dispose the tolerance ring depending on the position where the tolerance ring is disposed.

The present disclosure provides a power transmission system for a vehicle, including a spline-fitted part and a tolerance ring that are provided between a first rotary body and a second rotary body, the power transmission system capable of suppressing deterioration of machinability, and also provides a manufacturing method for the same.

One aspect of the present disclosure relates to a manufacturing method for a power transmission system for a vehicle. The vehicle includes: a first rotary body configured to rotate around an axial line; a second rotary body including a fitting hole into which one end portion of the first rotary body is fitted, the second rotary body being configured to rotate around the axial line; and a spline-fitted part configured such that external circumferential teeth provided on an outer circumferential surface of the first rotary body and internal circumferential teeth provided on an inner circumferential surface of the fitting hole are spline-fitted to each other. The manufacturing method includes: disposing a tolerance ring in an annular groove that is provided in an inner circumference of the second rotary body and is disposed at a more forward position than the spline-fitted part in a forward direction while the second rotary body is assembled to the first rotary body when the first rotary body and the second rotary body are fitted to each other, and assembling the first rotary body and the second rotary body to each other in such a manner as to bring the tolerance ring to come into contact with both the first rotary body and the second rotary body.

According to the aforementioned manufacturing method for the power transmission system for the vehicle, the tolerance ring is provided in the inner circumference of the second rotary body, and is disposed at a more forward position than the spline-fitted part in the forward direction while the second rotary body is assembled to the first rotary body, and thus the tolerance ring is disposed closer to the opening of the fitting hole of the second rotary body than to the spline-fitted part. Accordingly, it becomes easier to carry out machining to form the annular groove housing the tolerance ring therein in the inner circumference of the second rotary body, thus suppressing deterioration of machinability.

In the aforementioned manufacturing method for the power transmission system for the vehicle, a diameter of the first rotary body located at a more backward position than the external circumferential teeth in the forward direction while the first rotary body is assembled to the second rotary body may be equal to or larger than a diameter of a bottom of the external circumferential teeth of the first rotary body.

According to the aforementioned manufacturing method for the power transmission system for the vehicle, since the tolerance ring is disposed at a more forward position than the spline-fitted part in the forward direction of assembling the second rotary body to the first rotary body, the diameter of the first rotary body located at a more backward position than the external circumferential teeth of the first rotary body in the forward direction of assembling the first rotary body to the second rotary body can be set to be equal to or larger than the diameter of the bottom of the external circumferential teeth of the first rotary body. Accordingly, it is possible to suppress increase in height of the projections that are so provided to the tolerance ring 78 as to be in contact with both the first rotary body and the second rotary body, thus suppressing decrease in strength of the tolerance ring and deterioration of stability after the assembly thereof. On the other hand, if the tolerance ring is disposed at a more backward position in the forward direction than the spline-fitted part in the forward direction of assembling the second rotary body to the first rotary body, the outer diameter of the portion coming into contact with the tolerance ring of the first rotary body becomes smaller than the diameter of the bottom of the external circumferential teeth because of the limitation of machining of the external circumferential teeth. In addition, the inner diameter of the portion of the second rotary body where the annular groove is disposed becomes larger than the portion thereof where the internal circumferential teeth are disposed because of the limitation of machining of the internal circumferential teeth. Hence, in order to bring the tolerance ring to come into contact with both the first rotary body and the second rotary body, it is necessary to increase the height of the projections of the tolerance ring. Consequently, there might be caused decrease in strength of the tolerance ring and deterioration of stability after the assembly thereof.

In the aforementioned manufacturing method for the power transmission system for the vehicle, the power transmission system for the vehicle may include: a first planetary gear unit; a second planetary gear unit; and a third planetary gear unit, the first planetary gear unit, the second planetary gear unit, and the third planetary gear unit being configured to rotate around the axial line that is common to the first planetary gear unit, the second planetary gear unit, and the third planetary gear unit, the second planetary gear unit and the third planetary gear unit may be configured to be of a ravigneaux planetary gear unit in which a carrier of the second planetary gear unit and a carrier of the third planetary gear unit are configured as a common member and a ring gear of the second planetary gear unit and a ring gear of the third planetary gear unit are configured as a common member, a clutch may be provided between the ring gear of the first planetary gear unit and a sun gear of the third planetary gear unit, the spline-fitted part may be provided between the sun gear and a clutch drum of the clutch, the first rotary body may be the sun gear, and the second rotary body may be the clutch drum.

According to the aforementioned manufacturing method for the power transmission system for the vehicle, the spline-fitted part is provided between the sun gear and the clutch drum, and the tolerance ring is disposed at a more forward position than the spline-fitted part in the forward direction of assembling the clutch drum to the sun gear. Accordingly, the annular groove in which the tolerance ring is housed is provided at a position closer to the opening of the fitting hole than to the internal circumferential teeth of the clutch drum, thus facilitating machining of the annular groove.

In the aforementioned manufacturing method for the power transmission system for the vehicle, a wall thickness of a portion of the second rotary body where the annular groove is disposed may be thicker than a wall thickness of a portion of the first rotary body where the external circumferential teeth are disposed.

According to the aforementioned manufacturing method for the power transmission system for the vehicle, the wall thickness of the portion of the second rotary body where the annular groove is formed is thicker than the wall thickness of the portion of the first rotary body where the external circumferential teeth are formed, thus enhancing machinability in the grooving to form the annular groove in the second rotary body.

A second aspect of the present disclosure relates to a power transmission system for the vehicle. The power transmission system for the vehicle includes: a first rotary body configured to rotate around an axial line; a second rotary body having a fitting hole into which one end portion of the first rotary body is fitted, the second rotary body being configured to rotate around the axial line; a spline-fitted part configured such that external circumferential teeth provided on an outer circumferential surface of the first rotary body and internal circumferential teeth provided on an inner circumferential surface of the fitting hole are spline-fitted to each other; and a tolerance ring provided between the outer circumferential surface of the first rotary body and an inner circumferential surface of the second rotary body. The tolerance ring is housed in the annular groove disposed in the inner circumferential surface of the second rotary body, and is located at a position closer to an opening of the fitting hole than to the spline-fitted part in the axial line direction.

According to the aforementioned power transmission system for the vehicle, the tolerance ring is housed in the annular groove provided in the inner circumferential surface of the second rotary body, and is disposed at a position located closer to the opening of the fitting hole than to the spline-fitted part in the axial direction; thus, the annular groove is disposed at a position located closer to the opening of the fitting hole of the second rotary body than to the spline-fitted part. Accordingly, it becomes easier to carry out machining to form the annular groove where the tolerance ring is housed in the inner circumference of the second rotary body, thus suppressing deterioration of the machinability.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view of an essential part of a vehicle drive system to which the present disclosure is applied;

FIG. 2 is an engagement operation table showing combinations of clutches and brakes that establish respective shift positions of an automatic transmission;

FIG. 3 is a sectional view showing a part of the automatic transmission of FIG. 1;

FIG. 4 is an enlarged sectional view enlarging a vicinity of a coupled part between a sun gear and a clutch drum in FIG. 3;

FIG. 5 is a view of a tolerance ring of FIG. 4 as viewed from an arrow A direction;

FIG. 6 is a sectional view showing that the tolerance ring is housed on the sun gear side;

FIG. 7 is a sectional view showing that the tolerance ring is disposed at a position more backward in the forward direction than a spline-fitted part in a relative forward direction (assembling direction) of the clutch drum to the sun gear when the clutch drum is assembled to the sun gear; and

FIG. 8 is a flowchart explaining assembly steps of assembling the clutch drum to the sun gear.

### DETAILED DESCRIPTION OF EMBODIMENTS

Hereinafter, embodiments of the present disclosure will be described in details with reference to drawings. In the following embodiments, the drawings will be appropriately simplified or deformed, and the dimensional ratio, the shape and the like of each portion will not always be drawn accurately.

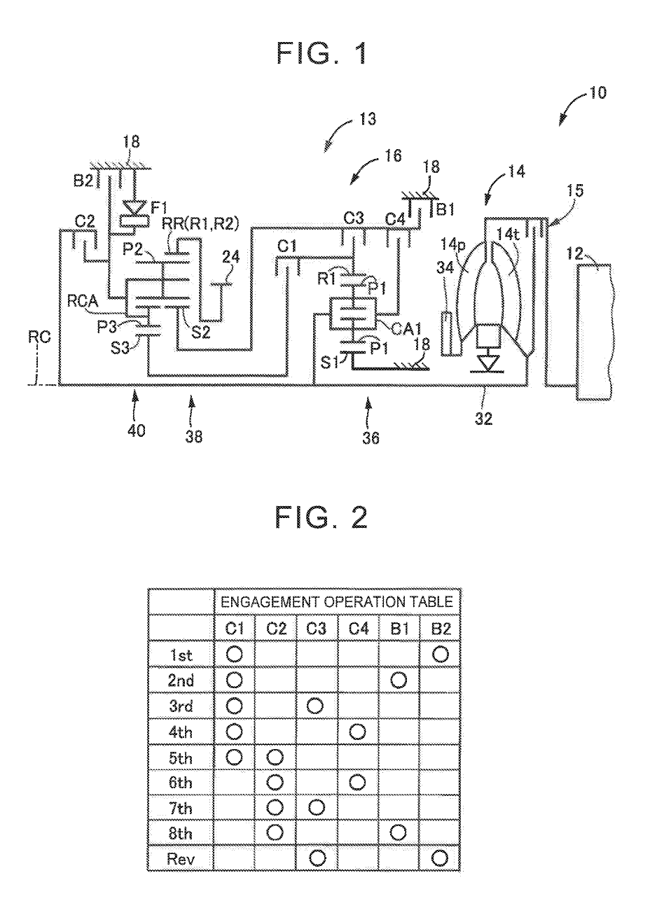

FIG. 1 is a view of an essential part of a vehicle drive system 10 to which the present disclosure is applied. The vehicle drive system is configured to include an engine 12 and a vehicle power transmission system (also referred to as a power transmission system for a vehicle) 13. The vehicle power transmission system 13 is configured to include a torque converter 14 and an automatic transmission 16. Each of the torque converter 14 and the automatic transmission 16 is arranged to be substantially symmetric relative to a center line (axial line RC), and an illustration of lower half parts thereof from the axial line RC is omitted in FIG. 1. The axial line RC in FIG. 1 is a rotational axial center (rotational center) of each of the engine 12, the torque converter 14, and the automatic transmission 16.

In FIG. 1, the torque converter 14 is so arranged as to be rotatable around the axial line RC, and includes: a pump impeller 14p coupled to the engine 12; and a turbine wheel 14t coupled to a transmission input shaft 32 that is an input rotary member of the automatic transmission 16. A mechanical-type oil pump 34 is coupled to the pump impeller 14p, and the oil pump 34 generates an operational hydraulic pressure used for a transmission control on the automatic transmission 16, and for supplying a lubrication oil to each part of a power transmission path of the automatic transmission 16. The torque converter 14 is provided with a lockup clutch 15 that directly couples the pump impeller 14p to the turbine wheel 14t.

The automatic transmission 16 is a planetary-gear-type multistep transmission composing a part of the power transmission path from the engine 12 to each not-shown driven wheel, and functioning as a stepped automatic transmission that forms multiple gear positions (shift positions) having different gear ratios (transmission gear ratios) by selectively engaging any one of multiple friction engagement devices (a first clutch C1 to a fourth clutch C4, a first brake B1, and a second brake B2) and a one-way clutch F1. For example, the automatic transmission 16 is a stepped transmission that carries out a so-called clutch-to-clutch transmission that is often used for a known vehicle. This automatic transmission 16 includes: a double-pinion-type first planetary gear unit 36; and a single-pinion-type second planetary gear unit 38 and a double-pinion-type third planetary gear unit 40 that are configured to be of a ravigneaux planetary gear unit on the same axial line (on the axial line RC), changes rotational speed of the transmission input shaft 32, and outputs the rotation from a transmission output shaft 24.

The first planetary gear unit 36 includes a first sun gear S1 that is an external gear, a first ring gear R1 that is an internal gear so arranged as to be concentric to the first sun gear S1, a first pinion gear P1 configured as a pair of gears that mesh with the first sun gear S1 and the first ring gear R1, and a first carrier CA1 that supports the first pinion gear P1 in a manner as to allow rotation of the first pinion gear P1 around its own axis as well as an orbital revolution thereof.

The second planetary gear unit 38 includes a second sun gear S2 that is an external gear, a second ring gear R2 that is an internal gear so arranged as to be concentric to the second sun gear S2, a second pinion gear P2 that meshes with the second sun gear S2 and the second ring gear R2, and a second carrier CA2 that supports the second pinion gear P2 in a manner as to allow rotation of the second pinion gear P2 around its own axis as well as an orbital revolution thereof.

The third planetary gear unit 40 includes a third sun gear S3 that is an external gear, a third ring gear R3 that is an internal gear so arranged as to be concentric to the third sun gear S3, a third pinion gear P3 configured as a pair of gears that mesh with the third sun gear S3 and the third ring gear R3, and a third carrier CA3 that supports the third pinion gear P3 in a manner as to allow rotation of the third pinion gear P3 around its own axis as well as an orbital revolution thereof.

The second carrier CA2 of the second planetary gear unit 38 and the third carrier CA3 of the third planetary gear unit 40 are configured as a common member, and the second ring gear R2 of the second planetary gear unit 38 and the third ring gear R3 of the third planetary gear unit 40 are configured as a common member. In addition, the second pinion gear P2 of the second planetary gear unit 38 is composed as a so-called ravigneaux-type gear train that functions as one of the pair of gears composing the third pinion gear P3 of the third planetary gear unit 40. Hereinafter, the second carrier CA2 and the third carrier CA3 are referred to as a carrier RCA as a common member, and the second ring gear R2 and the third ring gear R3 are referred to as a ring gear RR as a common member.

The first sun gear S1 is coupled to a case 18 that is a non-rotary member. The first carrier CA1 is coupled to the transmission input shaft 32, and is also coupled to the second sun gear S2 via the fourth clutch C4. The first ring gear R1 is coupled to the third sun gear S3 via the first clutch C1, and is also coupled to the second sun gear S2 via the third clutch C3. The second sun gear S2 is coupled to the case 18 via the first brake B1. The carrier RCA is coupled to the transmission input shaft 32 via the second clutch C2, and is also coupled to the case 18 via the second brake B2. The carrier RCA is coupled to the case 18 via the one way clutch F1 arranged in parallel to the second brake B2. The ring gear RR is coupled to the transmission output shaft 24.

The aforementioned first clutch C1, second clutch C2, third clutch C3, fourth clutch C4, first brake B1, and second brake B2 (referred to simply as clutches C, brakes B, or engagement devices unless otherwise distinguished) are a hydraulic friction engagement device often used in a known vehicle automatic transmission, and are configured as wet-type multi dick clutches and brakes pushed by a hydraulic actuator, or bandbrakes tightened by the hydraulic actuator. Each of the clutches C and the brakes B configured in such a manner is switched between engagement and disengagement by changing a torque capacity thereof (i.e. engagement force) by a not-shown hydraulic control circuit included in the automatic transmission 16.

By controlling engagement and disengagement of the clutches C and the brakes B, as shown in an engagement operation table of FIG. 2, respective gear positions including eight forward gear positions and one reverse gear position are formed in accordance with the accelerator operation by a driver, a vehicle velocity V, and others. “1st” to “8th” in FIG. 2 denote the first shift position to the eighth shift position as forward gear positions, and “Rev” denotes a reverse shift position as a backward gear position, and a gear ratio γ of the automatic transmission 16 corresponding to each shift position (=rotational speed of an input shaft of the transmission Nin/rotational speed of an output shaft thereof Nout) is appropriately defined depending on each gear ratio (=the number of teeth on the sun gear/the number of teeth on the ring gear) of the first planetary gear unit 36, the second planetary gear unit 38, and the third planetary gear unit 40.

As shown in the engagement operation table of FIG. 2, the first clutch C1 is brought to engage with the second brake B2 so as to establish the first gear position “1st”. The first clutch C1 is brought to engage with the first brake B1 so as to establish the second gear position “2nd”. The first clutch C1 is brought to engage with the third clutch C3 so as to establish the third gear position “3rd”. The first clutch C1 is brought to engage with the fourth clutch C4 so as to establish the fourth gear position “4th”. The first clutch C1 is brought to engage with the second clutch C2 so as to establish the fifth gear position “5th”. The second clutch C2 is brought to engage with the fourth clutch C4 so as to establish the sixth gear position “6th”. The second clutch C2 is brought to engage with the third clutch C3 so as to establish the seventh gear position “7th”. The second clutch C2 is brought to engage with the first brake B1 so as to establish the eighth gear position “8th”. The third clutch C3 is brought to engage with the second brake B2 so as to establish the reverse gear position “Rev”.

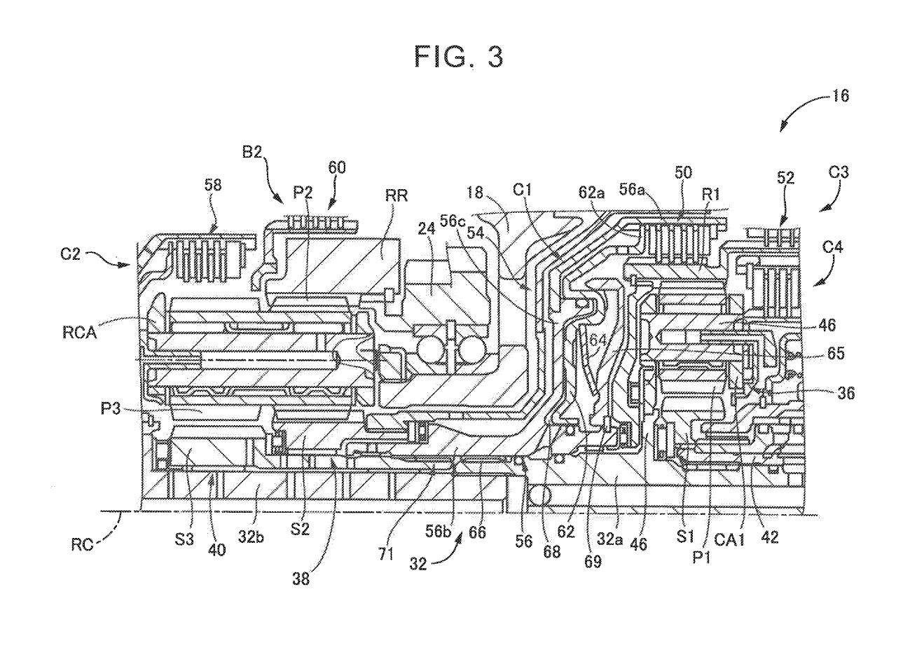

FIG. 3 is a sectional view showing a part of the automatic transmission 16 of FIG. 1. The automatic transmission 16 is configured to include, in the case 18 as the non-rotary member, the transmission input shaft 32, the transmission output shaft 24, the first planetary gear unit 36, the second planetary gear unit 38, and the third planetary gear unit 40. Each of the transmission input shaft 32, the first planetary gear unit 36 to the third planetary gear unit 40 is configured to be substantially symmetric to the axial line RC; therefore, an illustration of lower half parts thereof from the axial line RC is omitted in FIG. 3.

The transmission input shaft 32 is so arranged as to be rotatable around the axial line RC. The transmission input shaft 32 is configured as a first rotational shaft 32a located closer to the torque converter 14 in the axial line RC direction (on the right side in FIG. 3) and a second rotational shaft 32b located farther apart from the torque converter 14 in the axial line RC direction (on the left side in FIG. 3). The first rotational shaft 32a and the second rotational shaft 32b are spline-fitted to each other so as to be integrally rotated around the axial line RC. An end portion of the first rotational shaft 32a located closer to the torque converter 14 in the axial line RC direction is power-transmissibly coupled to the turbine wheel 14t of the torque converter 14.

From the torque converter 14 side in the axial line RC direction, the first planetary gear unit 36, the second planetary gear unit 38, and the third planetary gear unit 40 are arranged in this order with the axial line RC as a central axis of each of the units.

The first planetary gear unit 36 is configured as the double-pinion-type planetary gear unit. The first sun gear S1 of the first planetary gear unit 36 is coupled to an intermediate member 42 arranged on an outer circumference of the first rotational shaft 32a. The intermediate member 42 is coupled to the case 18 that is a non-rotary member. Therefore, the first sun gear S1 is so held as not to be rotatable all the time. The first carrier CA supports both ends of a pinion shaft 46 extending through the first pinion gear P1. The first carrier CA1 is coupled to a flange 46 of the first rotational shaft 32a, and is rotated together with the first rotational shaft 32a around the axial line RC. The first carrier CA1 is coupled to the fourth clutch C4. The first ring gear R1 is formed in an annular shape, and a friction engagement element 50 of the first clutch C1 and a friction engagement element 52 of the third clutch C3 are provided on an outer circumference of the first ring gear R1.

The second sun gear S2 of the second planetary gear unit 38 is formed in an annular shape, and is so provided as to be rotatable around the axial line RC. An external gear coming into mesh with the second pinion gear P2 is formed on an outer circumference of the second sun gear S2. Spline teeth (external circumferential teeth) are formed on an outer circumferential surface of the second sun gear S2 that is located closer to the torque converter 14 in the axial line RC direction, and are spline-fitted to internal spline teeth of a coupling drum 54. The coupling drum 54 is power-transmissibly coupled to the third clutch C3, the fourth clutch C4, and the first brake B1.

The third sun gear S3 of the third planetary gear unit 40 is formed in a substantially cylindrical shape, and an outer circumferential end portion thereof located closer to the torque converter 14 in the axial line RC direction is spline-fitted to a clutch drum 56 of the first clutch C1 described later. An external gear coming into mesh with the third pinion gear P3 is formed at an outer circumferential end portion of the third sun gear S3 that is located farther apart from the torque converter 14 in the axial line RC direction.

The carrier RCA common to both the second planetary gear unit 38 and the third planetary gear unit 40 supports the second pinion gear P2 and the third pinion gear P3 in a manner as to allow rotations of the second and third pinion gears P2, P3 around their own axes as well as orbital revolutions thereof. The ring gear RR common to both the second planetary gear unit 38 and the third planetary gear unit 40 is formed in an annular shape, and an inner circumference thereof is provided with an internal gear coming into mesh with the second pinion gear P2. The ring gear RR is so spline-fitted to the transmission output shaft 24 as to be integrally rotatable. A friction engagement element 58 of the second clutch C2 and a friction engagement element 60 of the second brake B2 are arranged circumferentially outward of the second planetary gear unit 38 and the third planetary gear unit 40.

The first clutch C1 that provides connection or disconnection in the power transmission path between the third sun gear S3 and the first ring gear R1 is disposed between the third sun gear S3 and the first ring gear R1 of the first planetary gear unit 36. The first clutch C1 is configured to include the clutch drum 56, the friction engagement element 50 provided between the clutch drum 56 and the first ring gear R1, a piston 62 pushing the friction engagement element 50, a spring 64 urging the piston 62 in a direction apart from the friction engagement element 50 in the axial line RC direction, and a supporting member 65 disposed to face the piston 62 so as to support the spring 64. The third sun gear S3 corresponds to a first rotary body of the present disclosure, the clutch drum 56 corresponds to a second rotary body of the present disclosure, and the first clutch C1 corresponds to a clutch of the present disclosure.

The clutch drum 56 is a cylindrical stepped member that includes a large-diameter cylindrical portion 56a, a small-diameter cylindrical portion 56b, and a disk portion 56c in a disk shape that couples the large-diameter cylindrical portion 56a and the small-diameter cylindrical portion 56b, and the clutch drum 56 is so supported as to be rotatable around the axial line RC.

The large-diameter cylindrical portion 56a of the clutch drum 56 is disposed circumferentially outward of the first ring gear R1, and the friction engagement element 50 formed by multiple friction plates is disposed between an inner circumferential surface of the large-diameter cylindrical portion 56a and an outer circumferential surface of the first ring gear R1. The friction engagement element 50 is formed by outer friction plates spline-fitted to the inner circumferential surface of the large-diameter cylindrical portion 56a and inner friction plates spline-fitted to the outer circumferential surface of the first ring gear R1, and the outer friction plates and the inner friction plates are alternately stacked one by one.

The small-diameter cylindrical portion 56b of the clutch drum 56 is disposed circumferentially outward of the transmission input shaft 32 and the third sun gear S3, and is supported via a roll bearing 66 or the like around the axial line RC. The disk portion 56c is disposed between the coupling drum 54 and the piston 62 in the axial line RC direction.

The piston 62 is formed in a disk shape, and is disposed between the clutch drum 56 (disk portion 56c) and a supporting member 65 in the axial line RC direction. An inner circumferential end portion of the piston 62 is fitted to an outer circumferential surface of the small-diameter cylindrical portion 56b of the clutch drum 56 in such a manner as to be relatively moveable in the axial line RC direction. An outer circumferential end portion of the piston 62 is spline-fitted to the inner circumferential surface of the large-diameter cylindrical portion 56a of the clutch drum 56 so that the piston 62 is integrally rotated together with the clutch drum 56, and is allowed to relatively move in the axial line RC direction relative to the clutch drum 56. The piston 62 is provided with a pushing portion 62a at a position adjacent to the friction engagement element 50 in the axial line RC direction, and when the piston 62 moves toward the friction engagement element 50 in the axial line RC direction, the pushing portion 62a pushes the friction engagement element 50 so as to bring the first clutch C1 into an engagement state or a slip-engagement state. The piston 62 is moved in the axial line RC direction by supplying operation oil to an oil pressure chamber 68 that is an oil-tight space surrounded by the piston 62 and the clutch drum 56.

The spring 64 is inserted between the piston 62 and the supporting member 65 in the axial line RC direction with a load applied thereto, so that the piston 62 is always pushed in a direction apart from the friction engagement element 50 in the axial line RC direction. The supporting member 65 abuts to a snap ring 69 fitted to the outer circumferential surface of the small-diameter cylindrical portion 56b, thereby restricting movement of the supporting member 65 in a direction apart from the piston 62 in the axial line RC direction.

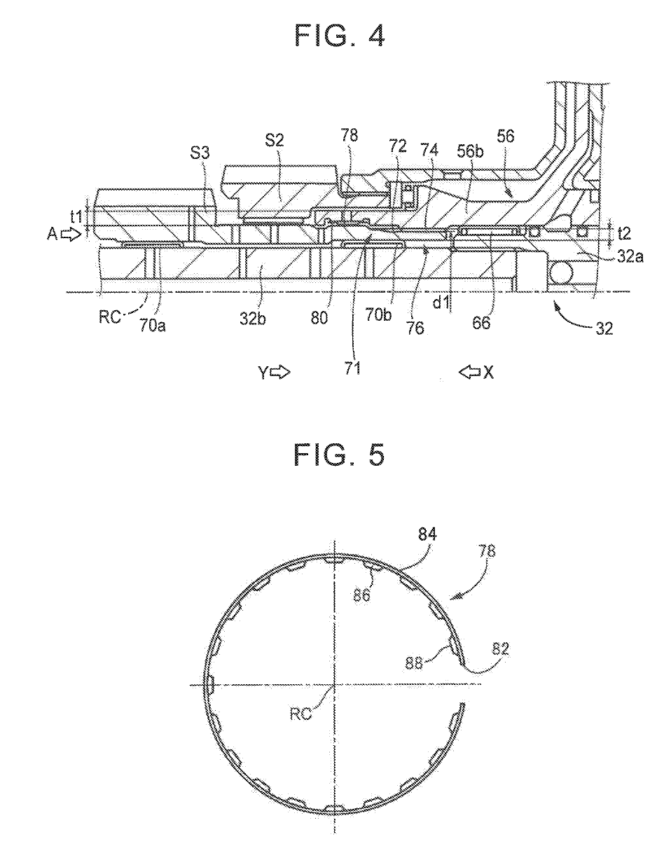

Next, a structure of a coupled part between the third sun gear S3 and the clutch drum 56 (small-diameter cylindrical portion 56b) will be described hereinafter. FIG. 4 is an enlarged sectional view enlarging the vicinity of the coupled part between the third sun gear S3 and the clutch drum 56 in FIG. 3.

The transmission input shaft 32 is so disposed as to be rotatable around the axial line RC. The third sun gear S3 is disposed circumferentially outward of the transmission input shaft 32. The third sun gear S3 has a cylindrical shape, and is so supported as to be rotatable around the axial line RC via roll bearings 70a, 70b and others inserted between the outer circumferential surface of the transmission input shaft 32 and the inner circumferential surface of the third sun gear S3. The clutch drum 56 (small-diameter cylindrical portion 56b) is so supported as to be rotatable around the axial line RC via a roll bearing 66 and others inserted between the small-diameter cylindrical portion 56b and the transmission input shaft 32.

The third sun gear S3 and the clutch drum 56 are spline-fitted to each other. A fitting hole 71 is formed in a part of the clutch drum 56 that faces the third sun gear S3 in the axial line RC direction, and one end portion of the third sun gear S3 is fitted into the fitting hole 71. Hence, an axial end of the small-diameter cylindrical portion 56b of the clutch drum 56 whose diameter is larger than that of the third sun gear S3 is arranged circumferentially outward of the axial end portion of the third sun gear S3 located closer to the torque converter 14 in the axial line RC direction (on the right side in FIG. 4). Accordingly, the axial end portion of the third sun gear S3 located closer to the torque converter 14 in the axial line RC direction and the axial end portion of the small-diameter cylindrical portion 56b located farther apart from the torque converter 14 in the axial line RC direction (on the left side in FIG. 4) partially overlap each other as viewed from the radial direction. Specifically, one end portion of the third sun gear S3 and one end portion of the clutch drum 56 that face each other partially overlap each other in the radial direction.

External circumferential spline teeth 72 are formed at an outer circumferential end portion of the third sun gear S3 located closer to the torque converter 14 in the axial line RC direction. Internal circumferential spline teeth 74 are formed on an inner circumferential surface of the clutch drum 56 (inner circumferential surface of the fitting hole 71) that overlap the external circumferential spline teeth 72 as viewed in the radial direction. The position where the internal circumferential spline teeth 74 are formed corresponds to a position in a part of the clutch drum 56 (small-diameter cylindrical portion 56b) that overlaps the third sun gear S3 in the radial direction, the position being located closer to the torque converter 14 (on the right side of FIG. 4) in the axial line RC direction. The external circumferential spline teeth 72 of the third sun gear S3 and the internal circumferential spline teeth 74 of the clutch drum 56 are spline-fitted to each other, thereby forming a spline-fitted part 76. The external circumferential spline teeth 72 correspond to external circumferential teeth of the present disclosure, and the internal circumferential spline teeth 74 correspond to internal circumferential teeth of the present disclosure.

In a part where the third sun gear S3 and the clutch drum 56 overlap each other in the radial direction, a tolerance ring 78 is disposed between the outer circumferential surface of the third sun gear S3 and the inner circumferential surface of the clutch drum 56 (small-diameter cylindrical portion 56b) with the tolerance ring 78 in contact with both the members. The tolerance ring 78 is disposed at a position farther apart from the torque converter 14 than from the spline-fitted part 76 in the axial line RC direction. In other words, when the third sun gear S3 and the clutch drum 56 are assembled, the tolerance ring 78 is located at a more forward position (on the left side of FIG. 4) than the spline-fitted part 76 in the (relative) forward direction (in the leftward direction in FIG. 4) while the clutch drum 56 is assembled to the third sun gear S3. The tolerance ring 78 is housed in an annular groove 80 formed in the inner circumferential surface of the fitting hole 71 of the clutch drum 56. This annular groove 80 is also formed at a more forward position than the spline-fitted part 76 (internal circumferential spline teeth 74) in the (relative) forward direction while the clutch drum 56 is assembled to the third sun gear S3, that is, at a position in the clutch drum 56 located closer to the opening of the fitting hole 71 than to the spline-fitted part 76 (internal circumferential spline teeth 74) in the axial line RC direction after the assembly. The annular groove 80 is formed by a cutting tool that is inserted from the opening of the fitting hole 71 of the clutch drum 56.

The forward direction while the clutch drum 56 is assembled to the third sun gear S3 is a relative moving direction of the clutch drum 56 relative to the third sun gear S3 when the clutch drum 56 is assembled to the third sun gear S3, and corresponds to a direction indicated by an arrow X in FIG. 4. The moving direction while the third sun gear S3 is assembled to the clutch drum 56 is a relative moving direction of the third sun gear S3 relative to the clutch drum 56 when the clutch drum 56 is assembled to the third sun gear S3, and corresponds to a direction indicated by an arrow Y in FIG. 4.

FIG. 5 is a view of the tolerance ring 78 of FIG. 4 as viewed from an arrow A direction (a direction parallel to the axial line RC) in FIG. 4. The tolerance ring 78 is composed of a metallic elastic material, and is an annular member having a cut-out 82 formed in a circumferential part of the tolerance ring 78. The tolerance ring 78 includes an annular portion 84 formed in a substantially annular shape, and multiple inward projections 86 projecting radially inward from an inner circumferential surface of the annular portion 84. The annular portion 84 has the cut-out 82 formed in a circumferential part thereof, and thus is elastically deformable. Accordingly, since the annular portion 84 is deformed, it is possible to previously fit the tolerance ring 78 into the annular groove 80 of the clutch drum 56. The inward projections 86 are arranged on the inner circumferential surface of the annular portion 84 with equal intervals in the circumferential direction. An outer circumferential surface of the annular portion 84 is in contact with the clutch drum 56 (annular groove 80) in an assembled state thereof. In addition, a projecting surface 88 of each inward projection 86 is in contact with the outer circumferential surface of the third sun gear S3 in the assembled state thereof.

As aforementioned, the tolerance ring 78 is housed in the annular groove 80 formed in the clutch drum 56, and is disposed at a more forward position (the left side in FIG. 4) than the spline-fitted part 76 in the forward direction (leftward direction in FIG. 4) of the clutch drum 56 relative to the third sun gear S3 when the third sun gear S3 and the clutch drum 56 are assembled.

In other words, no annular groove for housing the tolerance ring 78 therein is formed in the third sun gear S3. In this manner, no annular groove is formed in the third sun gear S3, and thus a diameter of the third sun gear S3 except for a portion thereof where the external circumferential spline teeth 72 (spline-fitted part 76) is formed is set to be equal to or larger than a diameter dl of a bottom of the external circumferential spline teeth 72. Specifically, when the third sun gear S3 and the clutch drum 56 are assembled, an outer diameter of the third sun gear S3 located more backward (farther apart from a first rotational shaft 32a in the axial line RC direction) than the external circumferential spline teeth 72 (spline-fitted part 76) of the third sun gear S3 in the (relative) forward direction (rightward direction in FIG. 4) during the assembly of the third sun gear S3 to the clutch drum 56 is set to be equal to or larger than the diameter dl of the bottom of the external circumferential spline teeth 72. Accordingly, in the third sun gear S3, the other portion has a thicker wall thickness than that of the portion where the external circumferential spline teeth 72 are formed, and thus insufficiency in strength of the third sun gear S3 is prevented. In addition, the wall thickness t1 (before machining) of the portion of the clutch drum 56 where the annular groove 80 is formed is set to be thicker than a wall thickness t2 (before machining) of the portion of the third sun gear S3 where the external circumferential spline teeth 72 (spline-fitted part 76) are formed (t1>t2). Accordingly, deformation caused during the grooving to form the annular groove 80 in the clutch drum 56 is reduced, thus the machinability is enhanced. Torque transmitted to the portion of the clutch drum 56 where the annular groove 80 is formed is smaller than that of the spline-fitted part 76; thus, this becomes advantageous in strength even after the assembly.

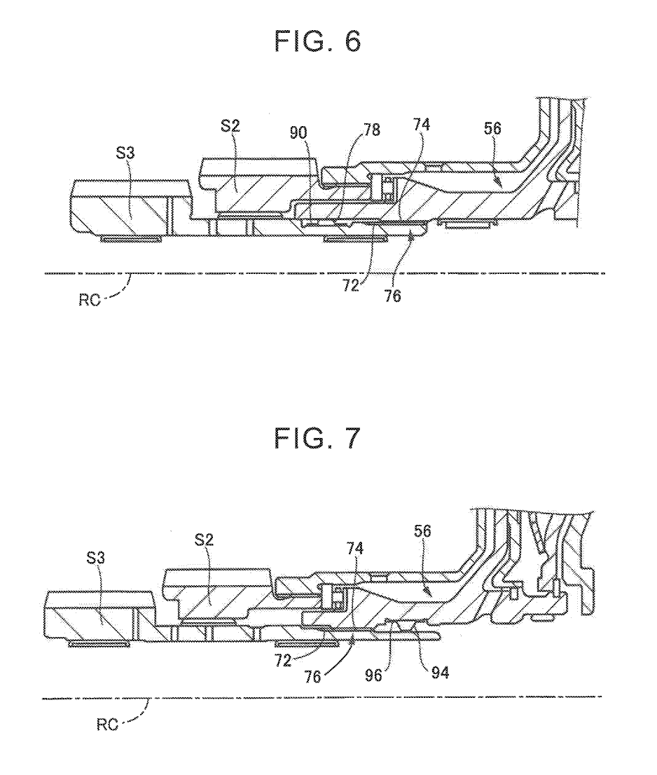

As a reference case, FIG. 6 is a sectional view showing that the tolerance ring 78 is housed in the third sun gear S3. As shown in FIG. 6, if an annular groove 90 in which the tolerance ring 78 is housed is formed in the third sun gear S3, a wall thickness of the portion of the third sun gear S3 where the annular groove 90 is formed is thinner than that a wall thickness of the portion thereof where the external circumferential spline teeth 72 are formed. Here, if torque is transmitted from the clutch drum 56 side, the torque is transmitted to the third sun gear S3 via the spline-fitted part 76. At this time, the portion of the third sun gear S3 where the annular groove 90 is formed is twisted, and the wall thickness of the portion becomes thinner; consequently, insufficiency in strength is caused in the portion.

In the present embodiment, when the clutch drum 56 is assembled to the third sun gear S3, since the annular groove 80 in which the tolerance ring 78 is housed is formed at a more forward position than the spline-fitted part 76 in the forward direction during the assembly of the clutch drum 56 to the third sun gear S3, the annular groove 80 is located closer to the opening of the fitting hole 71 of the clutch drum 56 than to the internal circumferential spline teeth 74; therefore, it becomes easier to carrying out the grooving of the annular groove 80, and thus the machinability is enhanced.

As a reference case, FIG. 7 is a sectional view showing that a tolerance ring 94 is disposed at a more backward position in the forward direction than the spline-fitted part 76 in the forward direction while the clutch drum 56 is assembled to the third sun gear S3 when the clutch drum 56 is assembled to the third sun gear S3. In this case, because of the limitation of spline-machining for the internal circumferential spline teeth 74 of the clutch drum 56, it is necessary to form an annular groove 96 having a greater diameter (inner diameter) than a diameter (inner diameter) of the internal circumferential spline teeth 74. In addition, the annular groove 96 is formed at a more backward position (more backward position in the forward direction during the assembly of the clutch drum 56) than the internal circumferential spline teeth 74 of the clutch drum 56; consequently, it becomes difficult to insert a cutting tool for forming the annular groove 96 from the opening of the fitting hole 71, which results in significant deterioration of the machinability.

As shown in FIG. 7, because of the limitation of the spline-machining, the outer diameter of the portion of the third sun gear S3 that comes into contact with the tolerance ring 94 is smaller than the diameter of the bottom of the external circumferential spline teeth 72. In addition, the diameter of the annular groove 96 is larger; thus, in order to bring the tolerance ring 94 to come into contact with both the third sun gear S3 and the clutch drum 56 (annular groove 96), it is necessary to set a height in the radial direction (height of inward projections) of the tolerance ring 94 to be higher. However, as the height in the radial direction of the tolerance ring 94 becomes higher, strength of the tolerance ring 94 and stability after the assembly thereof are more likely to be deteriorated. To the contrary, in the present embodiment, as shown in FIG. 4, the height of the inward projections 86 of the tolerance ring 78 is not increased, thus suppressing decrease in strength of the tolerance ring 78 and deterioration of stability after the assembly thereof.

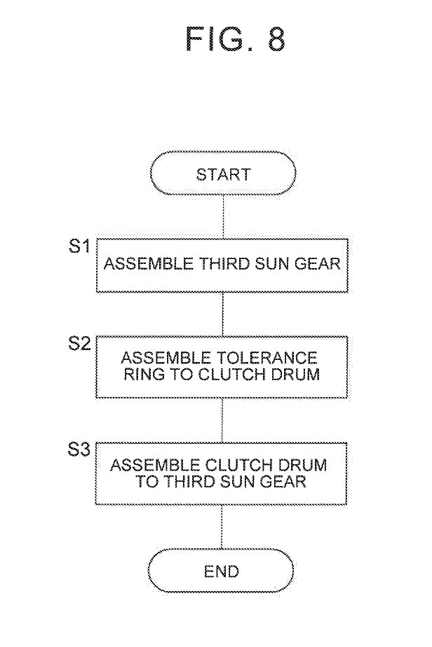

FIG. 8 is a flowchart explaining assembly steps of assembling the clutch drum 56 to the third sun gear S3. In a first step S1, the third sun gear S3 is assembled to the case 18. Subsequently, in a second step S2, the annular groove 80 is formed in the clutch drum 56 by cutting, and the tolerance ring 78 is then assembled into the annular groove 80. Here, since the annular groove 80 is formed in the inner circumference of the clutch drum 56 at a more forward position than the spline-fitted part 76 in the forward direction during the assembly of the clutch drum 56 to the third sun gear S3 when the third sun gear S3 and the clutch drum 56 are assembled, that is, at a position of the clutch drum 56 closer to the opening of the fitting hole 71 than to the internal circumferential spline teeth 74, and thus it becomes easier to insert the cutting tool when the annular groove 80 is formed, thereby facilitating the grooving. The second step S2 may be executed in a different manufacturing line. In a third step S3, the third sun gear S3 is assembled to the clutch drum 56. In the assembly-transitional state, the tolerance ring 78 is so assembled as to come into contact with both the outer circumferential surface of the third sun gear S3 and the inner circumferential surface (annular groove 80) of the clutch drum 56.

As aforementioned, according to the present embodiment, since the tolerance ring 78 is disposed in the inner circumference of the clutch drum 56 at a more forward position than the spline-fitted part 76 in the forward direction while the clutch drum 56 is assembled to the third sun gear S3; therefore, the tolerance ring 78 is located closer to the opening of the fitting hole 71 of the clutch drum 56 than to the spline-fitted part 76. Accordingly, it becomes easier to carrying out the grooving to form the annular groove 80 for housing the tolerance ring 78 therein in the inner circumference of the clutch drum 56, and the deterioration of the machinability is suppressed.

In addition, according to the present embodiment, since the tolerance ring 78 is disposed at a more forward position than the spline-fitted part 76 in the forward direction of assembling the clutch drum 56 to the third sun gear S3, a diameter of the third sun gear S3 located at a more backward position than the external circumferential spline teeth 72 in the forward direction of assembling the third sun gear S3 to the clutch drum 56 can be set to be larger than the diameter dl of the bottom of the external circumferential spline teeth 72. Accordingly, it is possible to suppress increase in height of the inward projections 86 that are so formed to the tolerance ring 78 as to come into contact with both the third sun gear S3 and the clutch drum 56, thus suppressing decrease in strength of the tolerance ring 78 and deterioration of stability after the assembly thereof.

According to the present embodiment, the wall thickness t1 of the portion of the clutch drum 56 where the annular groove 80 is formed is thicker than the wall thickness t2 of the portion of the third sun gear S3 where the external circumferential spline teeth 72 are formed (t1>t2); therefore, the machinability can be enhanced in the grooving to form the annular groove 80 in the clutch drum 56.

As aforementioned, the embodiments of the present disclosure have been described in details based on the drawings, and the present disclosure is also applicable to other aspects.

For example, in the aforementioned embodiments, the spline-fitted part 76 and the tolerance ring 78 are provided between the third sun gear S3 and the clutch drum 56, but the present disclosure is not always limited to the part between the third sun gear S3 and the clutch drum 56. The present disclosure may be appropriately applied to any part including a spline-fitted part formed by spline-fitting two rotary bodies to each other.

The above descriptions are merely one embodiment, and the present disclosure can be implemented in variously modified and improved forms based on the knowledge of those skilled in the art.

What is claimed is:

1. A manufacturing method for a power transmission system for a vehicle,
the vehicle including:
a first rotary body configured to rotate around an axial line;
a second rotary body including a fitting hole into which one end portion of the first rotary body is fitted, the second rotary body being configured to rotate around the axial line; and
a spline-fitted part configured such that external circumferential teeth provided on an outer circumferential surface of the first rotary body and internal circumferential teeth provided on an inner circumferential surface of the fitting hole are spline-fitted to each other,
the manufacturing method comprising:
disposing a tolerance ring in an annular groove that is provided in an inner circumference of the second rotary body and is disposed at a more forward position than the spline-fitted part in a forward direction while the second rotary body is assembled to the first rotary body when the first rotary body and the second rotary body are fitted to each other; and
assembling the first rotary body and the second rotary body to each other in such a manner as to bring the tolerance ring to come into contact with both the first rotary body and the second rotary body.

2. The manufacturing method according to claim 1, wherein
a diameter of the first rotary body located at a more backward position than the external circumferential teeth in the forward direction while the first rotary body is assembled to the second rotary body is equal to or larger than a diameter of a bottom of the external circumferential teeth of the first rotary body.

3. The manufacturing method according to claim 1, wherein
the power transmission system for the vehicle includes: a first planetary gear unit; a second planetary gear unit; and a third planetary gear unit, the first planetary gear unit, the second planetary gear unit, and the third planetary gear unit being configured to rotate around the axial line that is common to the first planetary gear unit, the second planetary gear unit, and the third planetary gear unit,
the second planetary gear unit and the third planetary gear unit are configured to be of a ravigneaux planetary gear unit in which a carrier of the second planetary gear unit and a carrier of the third planetary gear unit are configured as a common member and a ring gear of the second planetary gear unit and a ring gear of the third planetary gear unit are configured as a common member,
a clutch is provided between the ring gear of the first planetary gear unit and a sun gear of the third planetary gear unit,
the spline-fitted part is provided between the sun gear and a clutch drum of the clutch,
the first rotary body is the sun gear, and
the second rotary body is the clutch drum.

4. The manufacturing method according to claim 1, wherein
a wall thickness of a portion of the second rotary body where the annular groove is disposed is thicker than a wall thickness of a portion of the first rotary body where the external circumferential teeth are disposed.

5. A power transmission system for a vehicle, the power transmission system comprising:
a first rotary body configured to rotate around an axial line;
a second rotary body including a fitting hole into which one end portion of the first rotary body is fitted, the second rotary body being configured to rotate around the axial line;
a spline-fitted part configured such that external circumferential teeth provided on an outer circumferential surface of the first rotary body and internal circumferential teeth provided on an inner circumferential surface of the fitting hole are spline-fitted to each other; and
a tolerance ring provided between the outer circumferential surface of the first rotary body and an inner circumferential surface of the second rotary body,
wherein the tolerance ring is housed in an annular groove disposed in the inner circumferential surface of the second rotary body, and is located at a position closer to an opening of the fitting hole than to the spline-fitted part in an axial line direction.

6. The power transmission system for the vehicle according to claim 5, wherein
a diameter of the first rotary body located at a more backward position than the external circumferential teeth in a forward direction while the first rotary body is assembled to the second rotary body is equal to or larger than a diameter of a bottom of the external circumferential teeth of the first rotary body.

7. The power transmission system for the vehicle according to claim 5, wherein
the power transmission system for the vehicle includes: a first planetary gear unit; a second planetary gear unit; and a third planetary gear unit, the first planetary gear unit, the second planetary gear unit, and the third planetary gear unit are configured to rotate around the axial line that is common to the first planetary gear unit, the second planetary gear unit, and the third planetary gear unit,
the second planetary gear unit and the third planetary gear unit are configured to be of a ravigneaux planetary gear unit in which a carrier of the second planetary gear unit and a carrier of the third planetary gear unit are configured as a common member and a ring gear of the second planetary gear unit and a ring gear of the third planetary gear unit are configured as a common member,
a clutch is provided between the ring gear of the first planetary gear unit and a sun gear of the third planetary gear unit,
the spline-fitted part is provided between the sun gear and a clutch drum of the clutch,
the first rotary body is the sun gear, and
the second rotary body is the clutch drum.

8. The power transmission system for the vehicle according to claim 5, wherein
a wall thickness of a portion of the second rotary body where the annular groove is disposed is thicker than a wall thickness of a portion of the first rotary body where the external circumferential teeth are disposed.
